(19) United States
(12) Patent Application Publication
(10) Pub. No.: US 2022/0120133 A1
(43) Pub. Date: Apr. 21, 2022

(54) CURTAIN CORD RETRACTING AND RELEASING DEVICE AND TRANSMISSION MECHANISM THEREOF

(71) Applicant: Leafy Windoware Co., Ltd., Dongguan City, Guangdong Province (CN)

(72) Inventors: Zhenbang LEI, Dongguan City, Guangdong Province (CN); Xingbang LEI, Dongguan City, Guangdong Province (CN)

(21) Appl. No.: 17/426,639

(22) PCT Filed: Jul. 12, 2019
(86) PCT No.: PCT/CN2019/095794

§ 371 Date: Jul. 29, 2021

(51) Int. Cl. E06B 9/322

(52) U.S. Cl. CPC E06B 9/322; E06B 2009/3225

(57) ABSTRACT

A curtain cord retracting and releasing device includes a reel for winding a cord, a power mechanism, and a transmission mechanism for transmission between the power mechanism and the reel to drive the reel to rotate to retract or release the cord. The transmission mechanism includes two meshed external gears with the same structure. A center distance of the external gears is a fixed value, and one external gear is connected to an output shaft of the power mechanism and the other is connected to the reel. The external gears are non-circular gears with a radius of curvature of a pitch line gradually increasing. A gear tooth corresponding to a node with a smallest radius of curvature on the pitch line and a gear tooth corresponding to a node with a largest radius of curvature on the pitch line are transitioned by a curved surface.

### FIELD OF THE PRESENT INVENTION

The present invention relates to curtain technical field and, more particularly to a curtain cord retracting and releasing device and a transmission mechanism of the curtain cord retracting and releasing device.

### BACKGROUND OF THE PRESENT INVENTION

In a cord curtain, a cord connected with a curtain body is wound on a reel, and the reel can be rotated by a driving device, so that the cord is wound onto the reel or released from the reel, so as to realize the lifting or lowering of the curtain.

Some curtain driving devices use flat scroll springs to provide driving force. The torque change trend of traditional flat scroll springs is to meet the changing trend of the weight that the curtain driving device needs to support. After the reed of the flat scroll spring is bent and formed, the forming radius of curvature gradually increases from an inner ring toward an outer ring, and the smaller the forming radius of curvature of the reed, the greater the torque that can be provided. However, the production of such flat scroll springs is complicated and the cost is relatively high.

### SUMMARY OF THE INVENTION

### Technical Problem

Therefore, the technical problem to be solved by the embodiments of the present invention is to provide a transmission mechanism of a curtain cord retracting and releasing device, which is costly, and can effectively save effort when pulling a cord.

The technical problem to be further solved by the embodiments of the present invention is to provide a curtain cord retracting and releasing device, which is costly, and can effectively save effort when pulling a cord.

### SOLUTION OF THE PROBLEMS

### Technical Solutions

The technical problem to be solved by the embodiments of the present invention is to provide a transmission mechanism of a curtain cord retracting and releasing device, which is costly, and can effectively save effort when pulling a cord.

The technical problem to be further solved by the embodiments of the present invention is to provide a curtain cord retracting and releasing device, which is costly, and can effectively save effort when pulling a cord.

To solve the above-mentioned technical problems, an embodiment of the present invention provides a transmission mechanism of a curtain cord retracing and releasing device, for transmission between a power mechanism and a reel of the curtain cord retracting and releasing device. The transmission mechanism includes two external gears with the same structure and meshing with each other. A center distance of the two external gears is a fixed value, and one of the two external gears is connected to an output shaft of the power mechanism in a transmission mode and the other is connected to the reel in a transmission mode. The external gears are non-circular gears with a radius of curvature of a pitch line gradually increasing. A gear tooth corresponding to a node with a smallest radius of curvature on the pitch line and a gear tooth corresponding to a node with a largest radius of curvature on the pitch line are transitioned by a curved surface.

Furthermore, a middle of each external gear defines a central hole, an inner wall bounding the central hole is formed with an internal gear, and a sun gear and a planetary gear set are assembled in the central hole. A rotation axis of the sun gear coincides with a rotation axis of the external gear, and each planetary gear of the planetary gear set is meshed with the sun gear and the internal gear, respectively. The sun gear assembled in the middle of one of the external gears is fixedly connected to the output shaft of the power mechanism, and the sun gear assembled in the middle of the other external gear is fixedly connected to the reel.

Furthermore, at least one first partition plate that divides the central hole into multiple accommodation spaces in an axial direction is mounted in the central hole, and one sun gear and one corresponding planetary gear set are assembled in each accommodation space.

Furthermore, each of the least one first partition plate is fixed with one sun gear, and a center of each of the at least one first partition plate defines a through hole extending through the corresponding first partition plate and the corresponding sun gear. A plurality of planetary gear shafts protrudes from each of the at least one first partition plate, and one planetary gear is mounted to each of the plurality of planetary gear shafts. A mandrel protrudes from each of ends of the output shaft and the reel, the mandrel is inserted into the corresponding central hole, and extends through the corresponding through hole. A bottom end of the mandrel is fixed with a corresponding sun gear.

On the other hand, an embodiment of the present invention further provides a curtain cord retracing and releasing device including a reel for a cord being wound thereon, a power mechanism, and a transmission mechanism for transmission between the power mechanism and the reel to drive the reel to rotate to retract or release the cord. The transmission mechanism is the transmission mechanism as described in any one of the above mentioned.

Furthermore, the power mechanism includes a spring winding member and the output shaft whose central axes are arranged parallel to each other, and a plane scroll spring wound on the spring winding member. An outer end of the plane scroll spring is fixed to an outer surface of the output shaft.

Furthermore, the plane scroll spring is a plane scroll spring with a constant output torque.

Furthermore, the curtain cord retracting and releasing device further includes a housing. The reel, the power mechanism, and the transmission mechanism are all mounted in the housing. A side of the housing defines an opening, through which the cord extends. The housing is provided with a plurality of rods for positioning and guiding the cord.

Furthermore, the housing defines a positioning hole, and a pivot shaft protrudes from a center of an end of the reel. The reel is rotatably mounted to the housing through the pivot shaft being matched with the positioning hole. The spring winding member is rotatably mounted to the pivot shaft.

Furthermore, the reel defines two cord grooves, and the housing defines another opening in an opposite side for another cord extending therethrough. A second partition plate that divides each opening into two layers of channels is assembled at the position of the opening, and the cords respectively extending through the sides of the housing are extended through the channels of different layers of the corresponding openings to enter the housing, guided by the corresponding rods, and then wound onto different cord grooves of the reel.

### Beneficial Effect

By adopting the above technical solution, embodiments of the present application have at least the following beneficial effects. In the embodiments of the present application, the two external gears with the same structure and meshing with each other are used for transmission between the power mechanism and the reel. The center distance of the two external gears is a fixed value, and one of the two external gears is connected to the output shaft of the power mechanism in a transmission mode and the other is connected to the reel in a transmission mode. Since the center distance of the two external gears is a fixed value and the two external gears are non-circular gears and the curvature radius of the pitch line gradually increases, distances between a meshing point of the two external gears and the respective rotation centers will change at any time. When the distance between the meshing point of one external gear and the center of rotation gradually increases, the distance between the meshing point of the other external gear and the center of rotation must gradually decrease, and vice versa. Therefore, a transmission ratio of the two external gears will gradually change as the cord is retracted on or released from the reel, so that the torque transmitted by the power mechanism to the reel can be better matched with the pulling force required during the lifting or lowering process of the curtain body, which effectively achieves the effect of saving effort. The use of curved surface transition can make the tooth profile of the external gear form a complete circle, which facilitates the effective meshing and transmission of the two external gears.

### DESCRIPTION OF THE DRAWINGS

FIG. 1 is an exploded, isometric view of an embodiment of a curtain cord retracting and releasing device.

FIG. 2 is an assembled, isometric view of the embodiment of the curtain cord retracting and releasing device.

FIG. 3 is a cross-sectional view of the curtain cord retracting and releasing device, taken along a longitudinal axial plane, and with a cover being removed.

FIG. 4 is a cross-sectional view of a transmission mechanism of the curtain cord retracting and releasing device, taken along an end surface of a planetary gear.

FIG. 5 is an isometric view of a partitioning plate of an embodiment of the transmission mechanism.

### DETAILED DESCRIPTION OF THE PRESENT INVENTION

### Embodiments of the Present Application

The present application will be further described in detail below with reference to the accompanying drawings and specific embodiments. It should be understood that the following illustrative embodiments and illustrations are only used to explain the present invention and are not intended to limit the present invention, and that the embodiments of the present invention and the features of the embodiments can be combined with each other without conflict.

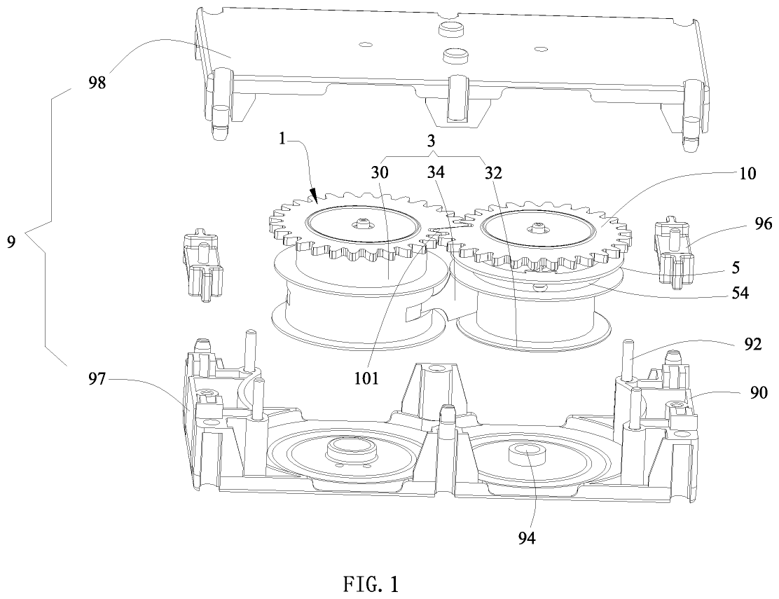

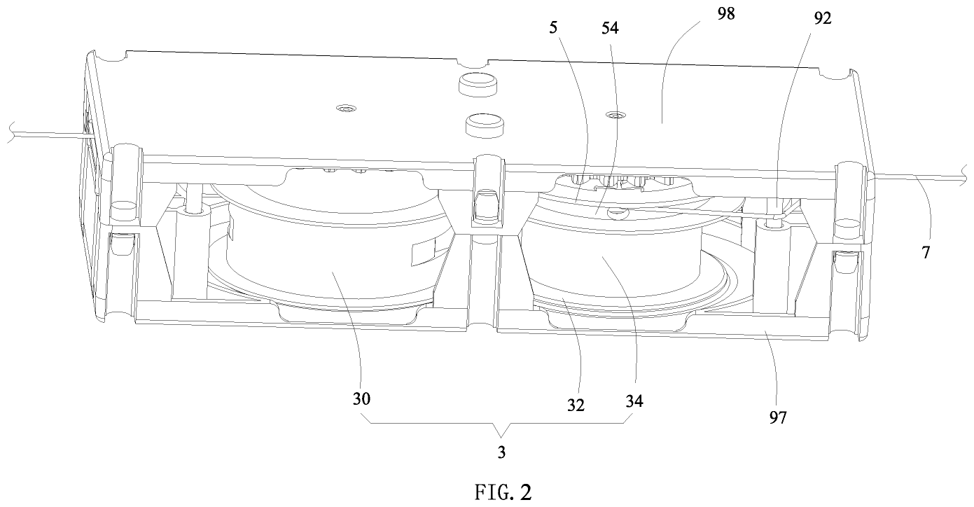

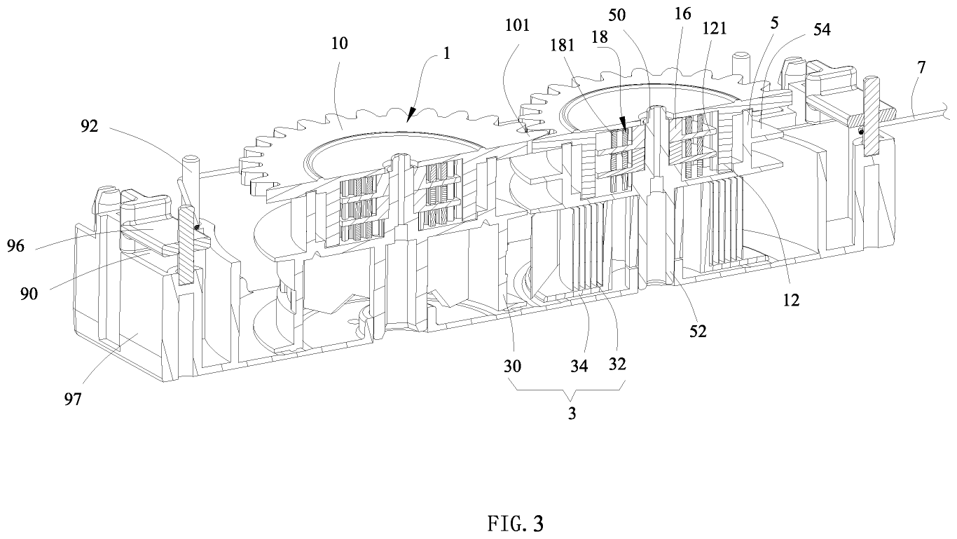

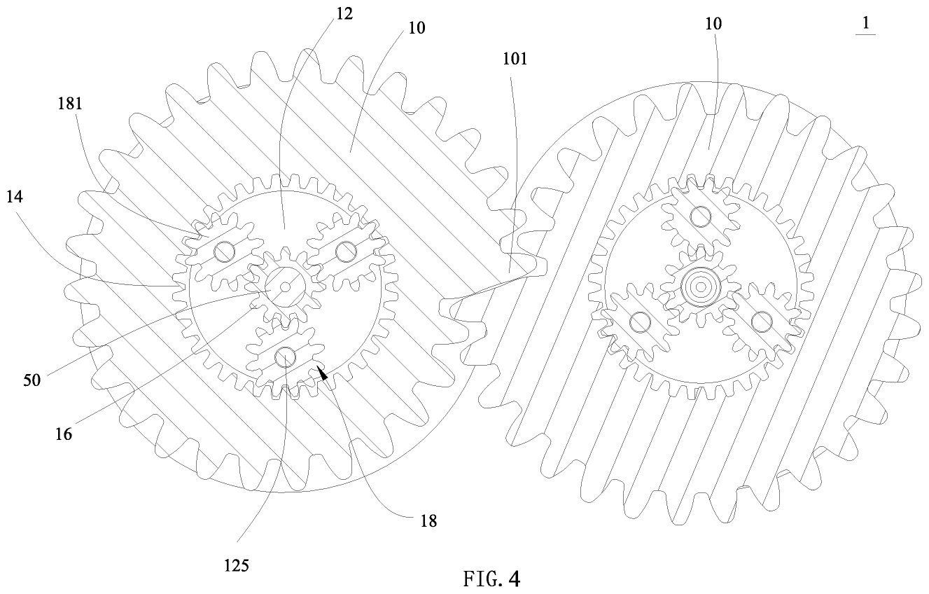

Referring to FIGS. 1-4, an embodiment of the present disclosure provides a transmission mechanism 1 of a curtain cord retracting and releasing device, for transmission between a power mechanism 3 and a reel 5 of the curtain cord retracting and releasing device to drive the reel 5 to rotate. The transmission mechanism 1 includes two external gears 10 with the same structure and meshing with each other. A center distance of the two external gears 10 is a fixed value, and one of the two external gears is connected to an output shaft 30 of the power mechanism 3 in a transmission mode and the other is connected to the reel 5 in a transmission mode. The external gears 10 are non-circular gears with a radius of curvature of a pitch line gradually increasing. A gear tooth 101 corresponding to a node with a smallest radius of curvature on the pitch line and a gear tooth 101 corresponding to a node with a largest radius of curvature on the pitch line are transitioned by a curved surface.

In the embodiment of the present application, the two external gears 10 with the same structure and meshing with each other are used for transmission between the power mechanism 3 and the reel 5. The center distance of the two external gears 10 is a fixed value, and one of the two external gears is connected to the output shaft 30 of the power mechanism 3 in a transmission mode and the other is connected to the reel 5 in a transmission mode. Since the center distance of the two external gears 10 is a fixed value, and the two external gears 10 are non-circular gears and the curvature radius of the pitch line gradually increases, distances between a meshing point of the two external gears 10 and the respective rotation centers will change at any time. When the distance between the meshing point of one external gear 10 and the center of rotation gradually increases, the distance between the meshing point of the other external gear 10 and the center of rotation must gradually decrease, and vice versa. Therefore, a transmission ratio of the two external gears 10 will gradually change as a cord 7 is retracted on or released from the reel 5, so that the torque transmitted by the power mechanism 3 to the reel 5 can be better matched with the pulling force required during the lifting or lowering process of a curtain body, which effectively achieves the effect of saving effort. The use of curved surface transition can make the tooth profile of the external gear 10 form a complete circle, which facilitates the effective meshing and transmission of the two external gears 10.

In an embodiment of the present application, a central hole 12 is defined in a middle of each external gear 10. An inner wall bounding the central hole 12 is formed with an internal gear 14, and a sun gear 16 and a planetary gear set 18 are assembled in the central hole 12. A rotation axis of the sun gear 16 coincides with a rotation axis of the external gear 10, and each planetary gear 181 of the planetary gear set 18 is meshed with the sun gear 16 and the internal gear 14, respectively. The sun gear 16 assembled in the middle of one of the external gears 10 is fixedly connected to the output shaft 30 of the power mechanism 3, and the sun gear 16 assembled in the middle of the other external gear 10 is fixedly connected to the reel 5. In the embodiment, by setting the internal gear 14, the sun gear 16, and the planetary gear set 18, and by setting a specific transmission ratio, the external gear 10 can rotate less and the reel 5 can rotate correspondingly more. The retracting or releasing operation of the cord is more labor-saving and convenient.

In an embodiment of the present application, the central hole 12 is equipped with a first partition plate 121 that divides the central hole 12 into multiple accommodation spaces in an axial direction. One sun gear 16 and one corresponding planetary gear set 18 are assembled in each accommodation space. In the embodiment, a plurality of sun gears 16 and a plurality of planetary gear sets 18 are provided, which can provide more stable supporting force and transmission force.

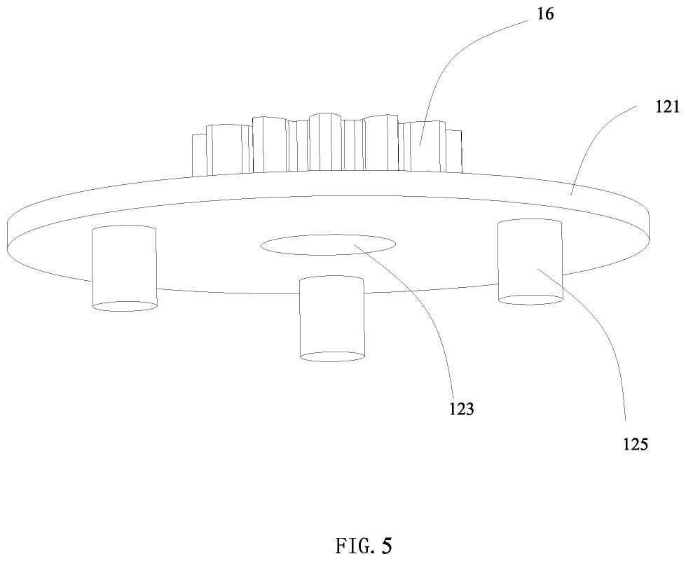

In an embodiment of the present application, referring to FIG. 5, each first partition plate 121 is fixed integrally with one sun gear 16, and a center of each first partition plate 121 defines a through hole 123 extending through the first partition plate 121 and the sun gear 16. A plurality of planetary gear shafts 125 protrudes from the first partition plate 121, and the planetary gears 181 are correspondingly mounted to the planetary gear shafts 125. A mandrel 50 protrudes from each of ends of the output shaft 30 and the reel 5. The mandrel 50 is inserted into the corresponding central hole 12, and extends through the corresponding through hole 123. One of the sun gears 16 is fixed to a bottom end of the mandrel 50. In the embodiment, by providing the first partition plate 121, and through the mandrel 50 and the planetary gear shafts 125 of each partition plate 121, it is convenient to assemble each planetary gear 181 and the sun gear 16.

On the other hand, an embodiment of the present application also provides a curtain cord retracting and releasing device, which includes a reel 5 on which a cord 7 is wound, a power mechanism 3, and a transmission mechanism 1 that transmits between the power mechanism 3 and the reel 5 to drive the reel 5 to rotate correspondingly to retract or release the cord 7. The transmission mechanism 1 is a transmission mechanism as described above.

In an embodiment of the present disclosure, the power mechanism 3 includes a spring winding member 32 and an output shaft 30 whose central axes are arranged parallel to each other, and a plane scroll spring 34 wound on the spring winding member 32. An outer end of the plane scroll spring 34 is fixed to an outer surface of the output shaft 30. In the embodiment, the plane scroll spring 34 is used and is arranged in parallel with the output shaft 30. The plane scroll spring 34 functions as a power component to drive the output shaft 30 to rotate. The assembling is convenient and the driving force provided is highly controllable. Therefore, the driving force required for the retracting or releasing of the cord 7 can be better designed, and the overall structure is simple, which is convenient for assembly and easy for manipulation.

In an embodiment of the present disclosure, the plane scroll spring 34 is a plane scroll spring with a constant output torque. Since the two external gears 10 can realize the real-time change of the transmission ratio, in the embodiment, the plane scroll spring 34 with a constant output torque can be used to achieve a smooth and labor-saving pulling of the cord 7, which can effectively reduce the cost of the plane scroll spring 34.

In an embodiment of the present disclosure, the curtain cord retracting and releasing device further includes a housing 9. The reel 5, the power mechanism 3, and the transmission mechanism 1 are all mounted in the housing 9. A side of the housing 9 defines an opening 90, through which the cord 7 extends. The housing 9 is also provided with a plurality of rods 92 for positioning and guiding the cord 7. In the embodiment, all the components are mounted in the housing 9 to simplify the installation structure, and the opening 90 and the rods 92 are provided to prevent the interference between the cord 7 and the components, which allows the pulling more smoothly.

In an embodiment of the present disclosure, the housing 9 defines a positioning hole 94. A pivot shaft 52 protrudes from a center of an end of the reel 5. The reel 5 is rotatably mounted to the housing 9 through the pivot shaft 52 being matched with the positioning hole 94. The spring winding member 32 is rotatably mounted to the pivot shaft 52. In the embodiment, the pivot shaft 52 is matched with the positioning hole 94, to simplify the installation structure of the reel 5 and the spring winding member 32 in the housing 9, optimize the layout, and reduce the occupied volume.

In an embodiment of the present disclosure, the reel 5 defines two cord grooves 54. Opposite sides of the housing 9 define two openings 90 for cords 7 extending therethrough, respectively. A second partition plate 96 that divides each opening 90 into two layers of channels is also assembled at the position of the opening 90, and the cords 7 respectively extending through the two sides of the housing 9 are extended through the channels of different layers of the corresponding openings to enter the housing 9, guided by the rods 92, and then wound onto different cord grooves 54 of the reel 5. In an embodiment, the housing includes a base 97 and a cover 98 buckled on the base 97. The base 97 and the cover shell 98 cooperate to form the openings 90, which facilitate the assembly of various structures. In the embodiment, the second partition plate 96 is used to divide the opening 90 into two layers, and the movement space of the cords 7 is divided into two layers to prevent the cords 7 located in the two grooves 54 of the reel 5 from interfering with each other.

The working principle of the curtain cord retracting and releasing device provided in the embodiments of the present application in practical application is as follows. When the curtain needs to cover the window, by pulling the curtain body downwards, the cords 7 are driven to be released from the reel 5 and to drive the reel 5 to rotate, so as to drive the sun gear 16, the planetary gear set 18, the internal gear 14, and the external gear 18 corresponding to the reel 5 to rotate in turn accordingly. The power is transmitted to the other external gear 10 mounted corresponding to the output shaft 30 of the power mechanism 3 through the meshing of the two external gears 10, and then the internal gear 14, the planetary gear set 18, and the sun gear 16 mounted in the other external gear 10 are driven in turn to rotate to transmit the power to the output shaft 30 of the power mechanism 3, so that the plane scroll spring 34 is gradually wound onto the output shaft 30 to gradually accumulate elastic potential energy. Through a reasonable transmission ratio design, one rotation of the external gear 10 can achieve the effect that the curtain body can be completely converted between a fully retracted state (completely unshielding the window) and a fully expanded state (completely shielding the window), and after the curtain body is moved in place, the curtain body will stop at any height due to the force balance. When the curtain needs to be opened again, a slight upward force needs to be applied to the curtain body to break the original force balance of the curtain body, and the plane scroll spring 34 will rewind to the spring winding member 32 and release the torque at the same time. The reel 5 is driven to rewind the cord 7 through the transmission of the transmission mechanism 1.

The embodiments of the present application have been described above with reference to the accompanying drawings, but the present application is not limited to the specific implementations described above, and the specific implementations described above are only schematic and not limiting. Under the enlightenment of this application, many forms can be made without departing from the scope of this application and the scope of protection of the claims, and these are all included in the scope of protection of this application.

### INDUSTRIAL APPLICABILITY

By adopting the above technical solution, the embodiment of the present application has at least the following beneficial effects. In the embodiment of the present application, the two external gears with the same structure and meshing with each other are used for transmission between the power mechanism and the reel. The center distance of the two external gears is a fixed value, and one of the two external gears is connected to the output shaft of the power mechanism in a transmission mode and the other is connected to the reel in a transmission mode. Since the center distance of the two external gears is a fixed value and the two external gears are non-circular gears and the curvature radius of the pitch line gradually increases, distances between a meshing point of the two external gears and the respective rotation centers will change at any time. When the distance between the meshing point of one external gear and the center of rotation gradually increases, the distance between the meshing point of the other external gear and the center of rotation must gradually decrease, and vice versa. Therefore, a transmission ratio of the two external gears will gradually change as the cord is retracted on or released from the reel, so that the torque transmitted by the power mechanism to the reel can be better matched with the pulling force required during the lifting or lowering process of the curtain body, which effectively achieves the effect of saving effort. The use of curved surface transition can make the tooth profile of the external gear form a complete circle, which facilitates the effective meshing and transmission of the two external gears.

1. A transmission mechanism of a curtain cord retracing and releasing device, for transmission between a power mechanism and a reel of the curtain cord retracting and releasing device, comprising:
two external gears with the same structure and meshing with each other, wherein a center distance of the two external gears is a fixed value, and one of the two external gears is connected to an output shaft of the power mechanism in a transmission mode and the other is connected to the reel in a transmission mode; wherein the external gears are non-circular gears with a radius of curvature of a pitch line gradually increasing, a gear tooth corresponding to a node with a smallest radius of curvature on the pitch line and a gear tooth corresponding to a node with a largest radius of curvature on the pitch line are transitioned by a curved surface.

2. The transmission mechanism of a curtain cord retracing and releasing device of claim 1, wherein a middle of each external gear defines a central hole, an inner wall bounding the central hole is formed with an internal gear, and a sun gear and a planetary gear set are assembled in the central hole; wherein a rotation axis of the sun gear coincides with a rotation axis of the external gear, and each planetary gear of the planetary gear set is meshed with the sun gear and the internal gear, respectively; the sun gear assembled in the middle of one of the external gears is fixedly connected to the output shaft of the power mechanism, and the sun gear assembled in the middle of the other external gear is fixedly connected to the reel.

3. The transmission mechanism of a curtain cord retracing and releasing device of claim 2, wherein at least one first partition plate that divides the central hole into multiple accommodation spaces in an axial direction is mounted in the central hole, one sun gear and one corresponding planetary gear set are assembled in each accommodation space.

4. The transmission mechanism of a curtain cord retracing and releasing device of claim 3, wherein each of the least one first partition plate is fixed with one sun gear, and a center of each of the at least one first partition plate defines a through hole extending through the corresponding first partition plate and the corresponding sun gear; wherein a plurality of planetary gear shafts protrudes from each of the at least one first partition plate, and one planetary gear is mounted to each of the plurality of planetary gear shafts; wherein a mandrel protrudes from each of ends of the output shaft and the reel, the mandrel is inserted into the corresponding central hole, and extends through the corresponding through hole; a bottom end of the mandrel is fixed with a corresponding sun gear.

5. A curtain cord retracing and releasing device, comprising:
a reel for a cord being wound thereon;
a power mechanism; and
a transmission mechanism for transmission between the power mechanism and the reel to drive the reel to rotate to retract or release the cord;
wherein the transmission mechanism is the transmission mechanism according to claim 1.

6. The curtain cord retracing and releasing device of claim 5, wherein the power mechanism comprises a spring winding member and the output shaft whose central axes are arranged parallel to each other, and a plane scroll spring wound on the spring winding member, wherein an outer end of the plane scroll spring is fixed to an outer surface of the output shaft.

7. The curtain cord retracing and releasing device of claim 6, wherein the plane scroll spring is a plane scroll spring with a constant output torque.

8. The curtain cord retracing and releasing device of claim 6, further comprising a housing, wherein the reel, the power mechanism, and the transmission mechanism are all mounted in the housing; a side of the housing defines an opening, through which the cord extends, the housing is provided with a plurality of rods for positioning and guiding the cord.

9. The curtain cord retracing and releasing device of claim 8, wherein the housing defines a positioning hole, a pivot shaft protrudes from a center of an end of the reel, the reel is rotatably mounted to the housing through the pivot shaft being matched with the positioning hole;
the spring winding member is rotatably mounted to the pivot shaft.

10. The curtain cord retracing and releasing device of claim 8, wherein the reel defines two cord grooves, the housing defines another opening in an opposite side for another cord extending therethrough; a second partition plate that divides each opening into two layers of channels is assembled at the position of the opening, and the cords respectively extending through the sides of the housing are extended through the channels of different layers of the corresponding openings to enter the housing, guided by the plurality of rods, and then wound onto different cord grooves of the reel.

11. The curtain cord retracting and releasing device of claim 9, wherein the reel defines two cord grooves, the housing defines another opening in an opposite side for another cord extending therethrough; a second partition plate that divides each opening into two layers of channels is assembled at the position of the opening, and the cords respectively extending through the sides of the housing are extended through the channels of different layers of the corresponding openings to enter the housing, guided by the plurality of rods, and then wound onto different cord grooves of the reel.

12. A curtain cord retracing and releasing device, comprising:
a reel for a cord being wound thereon;
a power mechanism; and
a transmission mechanism for transmission between the power mechanism and the reel to drive the reel to rotate to retract or release the cord;
wherein the transmission mechanism is the transmission mechanism according to claim 2.

13. The curtain cord retracing and releasing device of claim 12, wherein at least one first partition plate that divides the central hole into multiple accommodation spaces in an axial direction is mounted in the central hole, one sun gear and one corresponding planetary gear set are assembled in each accommodation space.

14. The curtain cord retracing and releasing device of claim 13, wherein each of the least one first partition plate is fixed with one sun gear, and a center of each of the at least one first partition plate defines a through hole extending through the corresponding first partition plate and the corresponding sun gear; wherein a plurality of planetary gear shafts protrudes from each of the at least one first partition plate, and one planetary gear is mounted to each of the plurality of planetary gear shafts; wherein a mandrel protrudes from each of ends of the output shaft and the reel, the mandrel is inserted into the corresponding central hole, and extends through the corresponding through hole; a bottom end of the mandrel is fixed with a corresponding sun gear.

15. The curtain cord retracing and releasing device of claim 12, wherein the power mechanism comprises a spring winding member and the output shaft whose central axes are arranged parallel to each other, and a plane scroll spring wound on the spring winding member, wherein an outer end of the plane scroll spring is fixed to an outer surface of the output shaft.

16. The curtain cord retracing and releasing device of claim 15, wherein the plane scroll spring is a plane scroll spring with a constant output torque.

17. The curtain cord retracing and releasing device of claim 15, further comprising a housing, wherein the reel, the power mechanism, and the transmission mechanism are all mounted in the housing; a side of the housing defines an opening, through which the cord extends, the housing is provided with a plurality of rods for positioning and guiding the cord.

18. The curtain cord retracing and releasing device of claim 17, wherein the housing defines a positioning hole, a pivot shaft protrudes from a center of an end of the reel, the reel is rotatably mounted to the housing through the pivot shaft being matched with the positioning hole; the spring winding member is rotatably mounted to the pivot shaft.

19. The curtain cord retracing and releasing device of claim 17, wherein the reel defines two cord grooves, the housing defines another opening in an opposite side for another cord extending therethrough; a second partition plate that divides each opening into two layers of channels is assembled at the position of the opening, and the cords respectively extending through the sides of the housing are extended through the channels of different layers of the corresponding openings to enter the housing, guided by the plurality of rods, and then wound onto different cord grooves of the reel.

20. The curtain cord retracting and releasing device of claim 18, wherein the reel defines two cord grooves, the housing defines another opening in an opposite side for another cord extending therethrough; a second partition plate that divides each opening into two layers of channels is assembled at the position of the opening, and the cords respectively extending through the sides of the housing are extended through the channels of different layers of the corresponding openings to enter the housing, guided by the plurality of rods, and then wound onto different cord grooves of the reel.
